(19) United States
(12) Patent Application Publication
(10) Pub. No.: US 2026/0113260 A1
(43) Pub. Date: Apr. 23, 2026

(54) COMMUNICATIONS NETWORK CONFIGURATION OPTIMIZATION METHOD AND APPARATUS

(71) Applicant: VERIZON PATENT AND LICENSING INC., Basking Ridge, NJ (US)

(72) Inventor: Sanjay Ravi VYAS, Miyapur (IN)

(73) Assignee: VERIZON PATENT AND LICENSING INC., Basking Ridge, NJ (US)

(21) Appl. No.: 18/923,934

(22) Filed: Oct. 23, 2024

(51) Int. Cl. H04L 43/0882

(52) U.S. Cl. CPC H04L 43/0882

(57) ABSTRACT

Techniques for optimizing paths for network communications traffic are disclosed. In one embodiment, a method is disclosed comprising obtaining, by computing device, for a plurality of network devices of a communications network, actual parametric values corresponding to multiple network communications path optimization factors, obtaining, by the computing device, target parametric values for the multiple factors, the target parametric values comprising target values corresponding to the actual parametric values, generating, by the computing device, model input for the plurality of network devices using the obtained actual and target parametric values, generating, by the computing device, path optimization recommendation information using a path optimization model and the model input, the path optimization recommendation information indicating at least one recommendation for optimizing a communications path of the communications network, and causing, by the computing device, at least one configuration change to the communications network in accordance with the at least one recommendation.

### BACKGROUND INFORMATION

User equipment (UE) can access a communications network, such as a 3GPP (3^{rd} Generation Partnership Project) 5G (Fifth Generation) communications network, via a new Radio Network (NG-RAN) of a base station, such as an enodeB or a gNodeB. The 5G network core can comprise a number of 5G Core network functions (NFs) that can provide services to other NFs, UEs, etc. The base station can be connected to the 5G network core via a transport network comprising a number of networked communication devices, such as and without limitation, routers, hubs, backhaul networks, terminal access points, service access points, etc. Traffic, e.g., traffic between UEs and the network core, can be routed based on defined communication paths. A communication path can connect a port of a network device to a port of another network device via a communication medium.

### BRIEF DESCRIPTION OF THE DRAWINGS

FIG. 1 provides an example illustrating components that can be used to provide path optimization functionality in accordance with one or more embodiments of the present disclosure;

FIG. 2 provides an example illustrating a communications network comprising network devices in accordance with one or more embodiments of the present disclosure;

FIG. 3 provides an example illustrating examples of factors for use in accordance with one or more embodiments of the present disclosure;

FIG. 4 provides a path optimization process flow in accordance with one or more embodiments of the present disclosure; and

FIG. 5 provides a block diagram illustrating a computing device showing an example of client or server device used in accordance with one or more embodiments of the present disclosure.

### DETAILED DESCRIPTION OF EXAMPLE EMBODIMENTS

Techniques for optimizing paths for traffic within a communications network, such as a 5G network, are disclosed. Unlike an approach in which a path for routing traffic is pre-configured based on a single factor, such as bandwidth, embodiments of the present disclosure can consider multiple factors, such as and without limitation quality of experience (QES), utilization, capacity, packet drops, power loss (or span loss), temperature, bandwidth, speed, etc., to dynamically optimize paths for routing traffic.

In accordance with one or more embodiments, multiple factors can be used to determine path optimization recommendation information, which can comprise recommendations for changing (e.g., increasing or decreasing) a communication path's bandwidth, rerouting, or diverting, some or all traffic from one path to another path or some combination. Path optimization recommendation information can be used to modify an initial or current configuration of a communications network. Embodiments of the present disclosure can be used to identify an optimal path for traffic in connection with existing components of a communications network or a new device being added to the communications network.

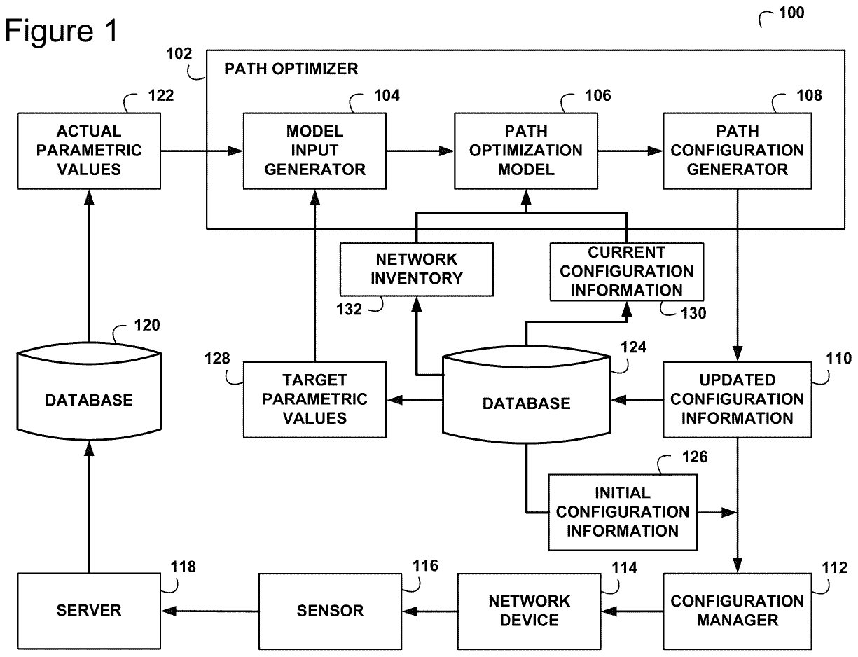

FIG. 1 provides an example illustrating components that can be used to provide path optimization functionality in accordance with one or more embodiments of the present disclosure. As shown in example 100, a path optimizer 102 can comprise model input generator 104, path optimization model 106 and path configuration generator 108. In accordance with one or more embodiments, model input generator 104 can generate input for path optimization model 106. Path optimization model 106 can use the generated input to generate path optimization recommendation information comprising a number of path optimization recommendations. The information generated by model 106 can include, for a respective recommendation, recommendation priority information, which can be used to make a determination whether or not to implement the respective recommendation.

In accordance with one or more embodiments, path configuration generator 108 can generate updated configuration information 110 and communicate updated configuration information 110 to configuration manager 112. Configuration manager 112 can cause network device 114 to update its configuration in accordance with updated configuration information 110.

In accordance with one or more embodiments, updated configuration information 110 can comprise information indicating a bandwidth change (e.g., increase or decrease in bandwidth) for a respective path, a diversion of traffic from one path to another path, or some combination of a bandwidth change or traffic diversion.

In accordance with one or more embodiments, path configuration generator 108 can use updated configuration information 110 to update a stored configuration in database 124 to reflect a current configuration. By way of a non-limiting example, updated configuration information 110 can be used to generate current configuration information 130.

Database 124 can comprise initial configuration information 126 used by configuration manager 112 to initially configure network device 114. Database 124 can comprise current configuration information 130, which can initially be set using initial configuration information 126. Database 124 can be updated to reflect any updated configuration information 110 provided by path configuration generator 108. Initial configuration information 126 and current configuration information 130 can each comprise information identifying each path configured between a pair of ports corresponding to a pair of network devices 114.

Database 124 can further include network inventory information 132, which can comprise information identifying each network device 114, each port of each network device, fiber optic, or other physical media, lines, etc. Database 124 can further include information indicating bandwidth capacities.

In accordance with one or more embodiments of the present disclosure, as discussed herein, model 106 can use current configuration information 130, network inventory information 132, actual parametric values 122, and target parametric values 128 to make path optimization recommendations. By way of some non-limiting examples, model 106 can comprise a single (or simple) exponential smoothing (SES) model or technique, a Long Short-Term Memory (LSTM) model, or the like.

In accordance with one or more embodiments, actual parametric values 122 can comprise information indicating operational conditions of network device 114 obtained from network device 114 via at least one of sensor 116.

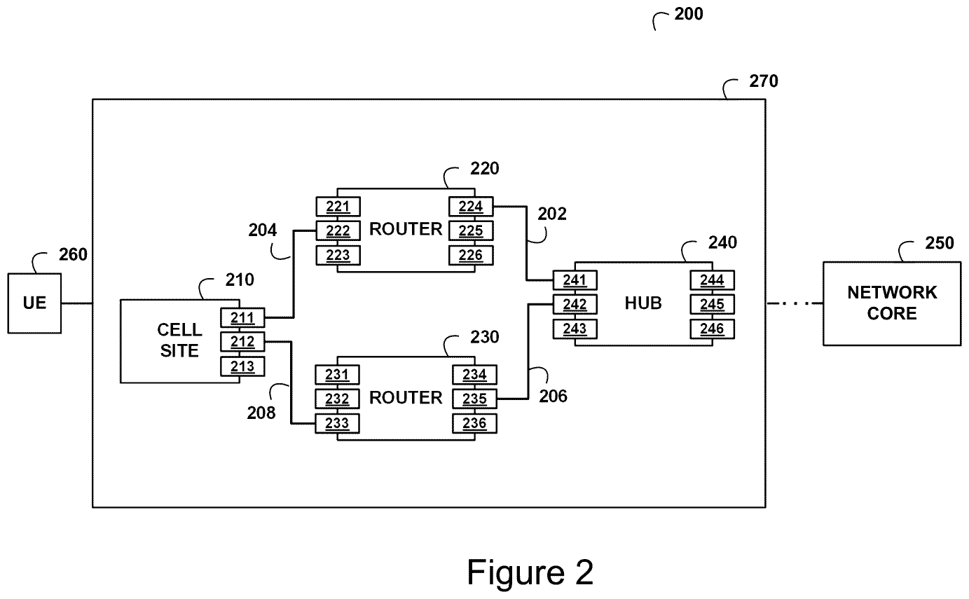

FIG. 2 provides an example illustrating a communications network comprising network devices in accordance with one or more embodiments of the present disclosure. In example 200, communications network 270 can be a 5G communications network comprising terminal access points (TAPs), service access points (SAPs) and number of network devices 114, such as and without limitation cell site 210, router 220, router 230 and hub 240. By way of a non-limiting example, cell site 210 can comprise network devices 114 (e.g., network interface devices) and other equipment (e.g., transmitters, receivers, etc.) that can be used to receive and transmit radio signals for cellular voice and data communications. Communications network 270 can be used by UE 260 and network core 250 to intercommunicate. In accordance with one or more embodiments, network core 250 can be provided by a cellular service (e.g., 5G) service provider.

In accordance with one or more embodiments of the present disclosure, each network device 114 of communications network 270 can comprise a number of ports. In example 200, cell site 210 can comprise ports 211-213, router 220 can comprise ports 221-226, router 230 can comprise ports 231-236 and hub 240 can comprise ports 241-246. In example 200, traffic, or network packets, can be routed via paths 202, 204, 206 and 208. Paths 202, 204, 206 and 208 can be wired or wireless connections. In examples described herein, paths 202, 204, 206 and 208 are fiber optic paths. It should be apparent that the paths can be any type of wired or wired connection and/or communications media.

Paths 202, 204, 206 and 208 can be used to route traffic (e.g., network packets) between UE 260 and network core 250. Each path can connect two network devices 114 via a port on each device. By way of a further non-limiting example, traffic can be routed between hub 240 and router 220 via path 202, port 241 of hub 240 and port 224 of router 220. By way of a further non-limiting example, traffic can be routed between hub 240 and router 230 via path 206, port 242 of hub 240 and port 235 of router 230.

In accordance with embodiments of the present disclosure, path optimizer 102 can be used to determine path optimization recommendation information, where path optimization recommendation information can comprise a recommendation for changing (e.g., increasing or decreasing) a communication path's bandwidth, rerouting traffic from one path to another path or some combination. In accordance with one or more embodiments, path optimizer 102 can consider multiple factors to determine the path optimization recommendation information. In accordance with one or more embodiments, each factor can be represented by parametric value information—i.e., actual and target parametric value information.

With reference to FIG. 1, server 118 can be configured to collect actual parametric values for each of the factors and store the values in database 120. Server 118 can obtain the actual parametric value for one or more of the factors from network device 114 via one or more instances of sensor 116. In accordance with one or more embodiments, one or more instances of sensor 116 can be associated with each instance of network device 114.

Sensor 116 can monitor network device 114 and provide actual parametric values indicating an operational status for network device 114. Actual parametric value information comprising operational status information can include capacity, utilization, speed, packet drops, power loss and temperature information. In accordance with one or more embodiments, operational status information can be obtained for each port of each network device 114 of an existing path—e.g., one of paths 202, 204, 206 or 208—or a potential communication path of communications network 270.

Capacity, or configured bandwidth, can indicate a maximum amount of data that can be transferred in a certain time interval (e.g., per second). Utilization can indicate a percentage of the capacity being used. Speed can indicate a maximum rate at which data can be transmitted. Packet drop can provide information indicating whether any packets have been dropped in connection with a path instance. Power loss, or span loss, can indicate, for a path instance, whether there is any loss in power across a span of fiber, or other physical communication medium.

By way of a non-limiting example, sensor 116 can be used to detect a level of power output, or transmitted, and a power level received. Transmitted and received power level values identified at each side of a path (e.g., path 202) can be used to identify power loss across the span (e.g., a span of fiber optic cabling). Temperature can indicate an internal temperature associated with a path instance as measured for a given port of network device 114.

In addition, information related to the actual parametric values associated with path optimization factors from sensor 116, server 118 can obtain information related to other factors, such as and without limitation QES and performance from customer satisfaction information maintained by the 5G provider's system. QES can be a score, or measure, of a level of customer satisfaction, or experience, and the performance factor can indicate whether or not any performance flags, tickets, etc. have been issued relative to a certain communication path. By way of a non-limiting example, QES can be based on one or more measures of performance and/or satisfaction, such as and without limitation quality of service (QoS), quality of experience (QoE), or the like.

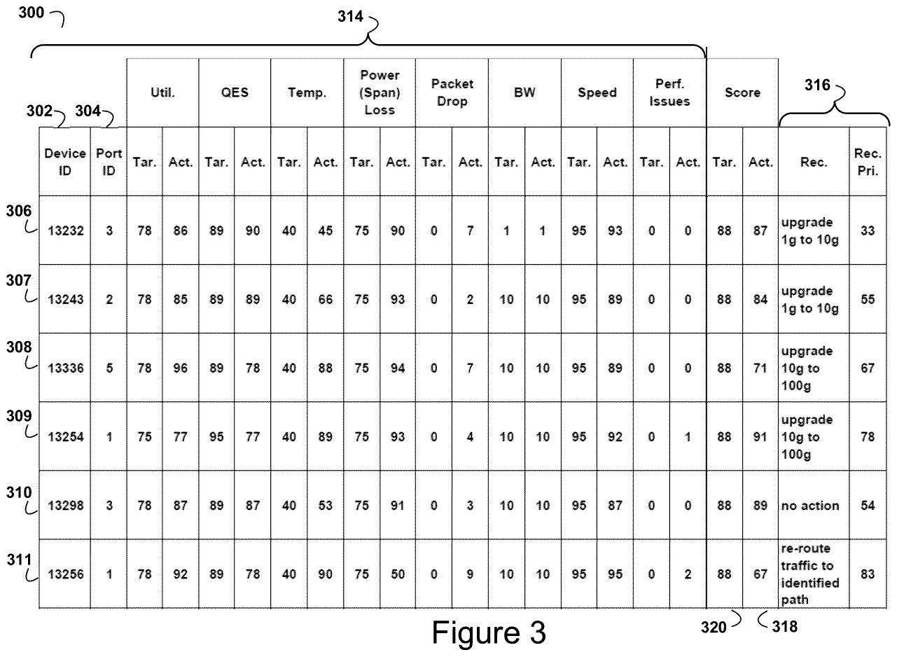

In accordance with one or more embodiments, model input generator 104 can generate model input using actual and target parametric values associated with each network device 114 and port pairing, where the actual and target parametric values for each pairing can correspond to the factors to be considered by path optimization model 106 in generating path optimization recommendation information. FIG. 3 provides an example illustrating examples of factors for use in accordance with one or more embodiments of the present disclosure.

Example 300 includes a table illustrating examples of model input 314 information that can be generated by model input generator 104 and model output 316 that can be generated by path optimization model 106. Each of rows 306-311 correspond to a respective port of a respective network device 114. Model input 314 includes device identification information (e.g., device ID) 302 and port identification information (e.g., port ID) 304 for the respective port and network device 114 pairing. In addition, model input 314 can include actual and target parametric values for each of number of factors that path optimization model 106 can consider in generating model output 316. In accordance with one or more embodiments, model input 314 can further include a target score 320 for each device and port pair.

In accordance with one or more embodiments, actual parametric values can be maintained by server 118 in database 120 and retrieved by model input generator 104. Database 124 can comprise target parametric values 128. While database 120 and 124 are shown in example 100 as being separate, database 120 and 124 can be the same.

In accordance with one or more embodiments, for a respective port of a network device 114, actual parametric values 122 comprise information indicating operational conditions for each of a plurality of factors being considered by model 106 in determining a path optimization recommendation information for the port and network device 114 pairing. In accordance with one or more embodiments, target parametric values 128 can indicate design values for each of the factors being considered by model 106. A factor's target parametric value can represent a desired value. The factor's target parametric value can be used as a threshold value to determine whether or not a current path is optimal, or whether a change including one or both of a path diversion or bandwidth change is to be made. In accordance with one or more embodiments, target parametric values can be configured globally across ports and network devices of communications network 270, for each port of each network device 114, for a group of network devices 114, etc.

By way of a non-limiting example and with reference to FIG. 3, a temperature factor includes a target parametric value and an actual parametric value in rows 306-311, each of which corresponds to a network device 114 and port combination, or pairing. The target parametric value indicates a target temperature of 40 degree. The actual parametric value of the temperature factor can represent an operational temperature corresponding to the device and port combination corresponding to row 311. An increase in operational temperature can impact performance and can indicate an increased usage. The target parametric value can represent a threshold operational temperature that can be used by model 106 for comparison with the actual parametric value to determine whether or not the actual parametric value exceeds the target operational temperature and is could be of concern.

In accordance with one or more embodiments, model 106 can use each factor's actual and target parametric values to generate model output 316 comprising recommended action and recommendation priority information for each network device 114 and port combination identified in model input 314. In accordance with one or more embodiments, information 316 output by model 106 can comprise a path optimization recommendation and an associated recommendation priority determined by model 106 using model input 314.

In accordance with one or more embodiments, model 106 can generate an actual score 318 using model input 314, and can compare the actual scores 318 and target scores 318 to determine the path optimization recommendation and associated recommendation priority information 316.

In accordance with one or more embodiments, the path optimization recommendation information generated by model 106 can comprise information indicating a type of action, where the type of action can include a “no action” recommendation or, alternatively, a recommendation to a network element or device to change bandwidth (e.g., increase or decrease in bandwidth), reroute traffic, or some combination thereof. The recommendation priority information associated with a respective network device 114 and port pair can indicate a priority, or level of importance, associated with the action indicated in the path optimization recommendation information provided by model 106.

With reference to example 200 of FIG. 2, assume a scenario in which current configuration information 130 input to model 106 indicates that network traffic from hub 240 to cell site 210 is being transmitted via path 206 and router 230, path 206 is currently configured with a 10 gigabyte (GB) bandwidth but can be increased to 100 GB, path 202 is available for rerouting traffic. Model output 316 from model 106 can include a recommendation to reroute at least some of the traffic from path 206 to path 202, increase bandwidth for path 206 to 100 GB, or a combination of traffic reroute and bandwidth change.

In accordance with one or more embodiments, path configuration generator 108 can generate updated configuration information 110 in accordance with model output 316 generated by model 106. By way of a non-limiting example, path configuration generator 108 can use path optimization recommendation information to determine a type of action for a network device 114 and port pair and determine whether or not to adopt the type of action based on the corresponding recommendation level. By way of a further non-limiting example, path configuration generator 108 can compare the recommendation priority to a threshold priority value, such that generator 108 can elect to take the recommended action indicated by the path optimization recommendation information in a case that the recommendation priority exceeds the threshold priority value.

In a case that generator 108 elects to take the action recommended by model 106, generator 108 can generate updated configuration information 110. Generator 108 can use the updated configuration information 110 to update current configuration information 130 stored in database 124, such that path optimization model 106 can be aware of the current configuration of communications network 270.

In accordance with one or more embodiments, path configuration generator 108 can make a determination to take a recommendation in connection with a communications path of the communications network, and can transmit updated configuration information 110 to configuration manager 112 instructing manager 112 to make the determined change(s), which can comprise a change (e.g., increase or decrease) bandwidth in connection with a port of network device 114, reroute, or divert, at least a portion of traffic in connection with a port of network device 114, or some combination thereof.

Generator 108 can instruct configuration manager 112 to use updated configuration information 110 to update the configuration of network device 114. Continuing with the example discussed above, assuming that network device 114 is hub 240, configuration manager 112 can configure hub 240 to divert some or all of traffic from port 242 and path 206 to port 241 and path 202, increase the bandwidth from 10 GB to 100 GB for port 242 and path 206, or some combination.

As discussed, path configuration generator 108 can update current configuration information 130 using updated configuration information 110, such that model 106 can use current configuration information 130 to generate model output 316 based on current configuration information 130 and actual parametric values 122 corresponding to communications network 270. Current configuration information 130 and actual parametric values 122 provide feedback to model 106 enabling model 106 to continue to learn from the updated information.

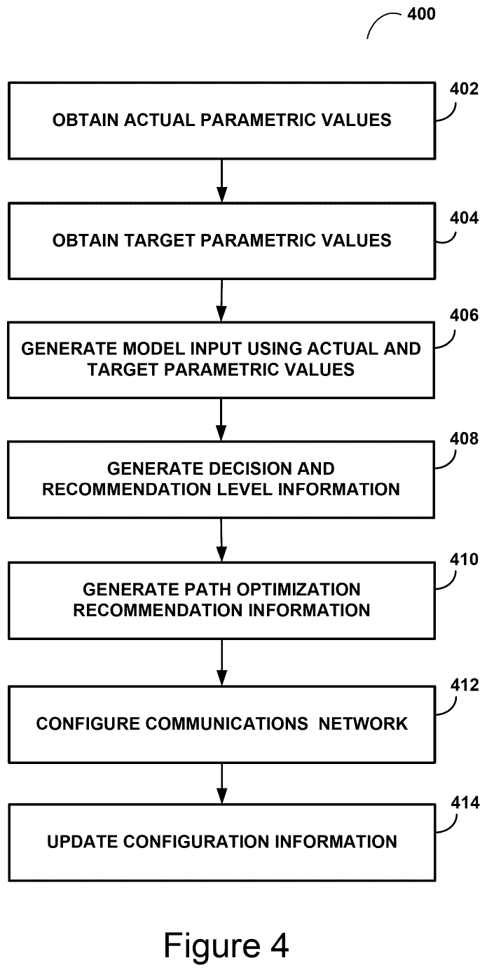

FIG. 4 provides a path optimization process flow in accordance with one or more embodiments of the present disclosure. Process flow 400 can be performed by path optimizer 102. In accordance with one or more embodiments, process flow 400 can be used to generate updated configuration information 110 identifying an optimal path between network devices 114 of communications network 270 using current configuration information 130, network inventory information 132, actual parametric values 122 and target parametric values 128. Network device 114 can be a new device being added to communications network 270 or an existing network device. In accordance with one or more embodiments, optimal path identification can comprise changing an existing communications path's bandwidth, rerouting some or all traffic from one path to another path or some combination.

At step 402, actual parametric values can be obtained from at least one network sensor. By way of a non-limiting example, step 402 can be performed by model input generator 104. Model input generator 104 can retrieve actual parametric values 122 from database 120. In accordance with one or more embodiments, actual parametric values 122 include information provided by sensor 116 about network device 114, along with other path optimization factor information, such as QES and performance information corresponding to network device 114.

At step 404, target parametric values can be obtained. By way of a non-limiting example, step 404 can be performed by model input generator 104. Model input generator 104 can retrieve target parametric values 128 from database 124. In accordance with one or more embodiments, target parametric values 128 be design values representing desired values for each of the factors being considered by model 106.

At step 406, model input can be generated using the actual and target parametric values. By way of a non-limiting example, step 406 can be performed by model input generator 104. Model input generator 104 can use the actual parametric values 122 and target parametric values 128 obtained at steps 402 and 404, respectively, to generate model input 314. As discussed, model input 314 can comprise, for each port of a network device 114, actual and target parametric values for each factor being considered by model 106.

At step 408, path optimization recommendation information can be generated. By way of a non-limiting example, step 408 can be performed by path optimization model 106. Path optimization model 106 can use model input 314, generated at step 406, network inventory information 132 and current configuration information 130 to generate model output 316 comprising recommendation and recommendation priority information for each network device 114 and port combination identified in model input 314.

In accordance with one or more embodiments, the recommendation generated by model 106 can comprise information indicating a type of action, where the type of action can include a “no action” recommendation or, alternatively, a recommended action, where the recommended action can be a bandwidth change (e.g., increase or decrease in bandwidth), traffic reroute, or some combination thereof. The recommendation priority information associated with a recommendation for a respective network device 114 and port pair can indicate a level of importance, priority, etc., for taking the recommended action indicated by the recommendation information provided by model 106.

At step 410, configuration update information can be generated. By way of a non-limiting example, step 410 can be performed by path configuration generator 108. Path configuration generator 108 can generate updated configuration information 110 using model output 316 comprising recommendation, or recommended action, and recommendation priority information for each network device and port combination identified in model input 314.

By way of a non-limiting example, path configuration generator 108 can use path optimization recommendation information, provided by model 106 as output 316, to determine a type of action for a network device 114 and port pair and determine whether or not to adopt the type of action based on the corresponding recommendation level. By way of a further non-limiting example, path configuration generator 108 can use a threshold value in comparison with a recommendation priority to determine whether or not to take the recommended action indicated by the path optimization recommendation information. By way of a further non-limiting example, path configuration generator 108 can elect to take the recommended action in a case that the recommendation level exceeds the threshold value.

In a case that generator 108 elects to take the recommended action indicated by the path optimization recommendation information output by model 106, generator 108 can generate updated configuration information 110 including the recommended action.

In accordance with one or more embodiments, updated configuration information 110 can comprise information indicating a bandwidth change in connection with an existing communications path, a rerouting of traffic from one path to another path, or some combination of a bandwidth change (e.g., increase or decrease in bandwidth) or traffic reroute. As discussed, updated configuration information 110 can be used to update current configuration information 130 stored in database 124.

At step 412, the communications network can be configured. By way of a non-limiting example, step 412 can be performed by configuration manager 112. Path configuration generator 108 can instruct configuration manager 112 to use updated configuration information 110 to update the configuration of network device 114.

At step 414, configuration information can be updated. By way of a non-limiting example, step 414 can be performed by path configuration generator 108. Path configuration generator 108 can use updated configuration information 110 to update current configuration information 130, such that path optimization model 106 can be aware of any configuration updates made by path configuration generator 108.

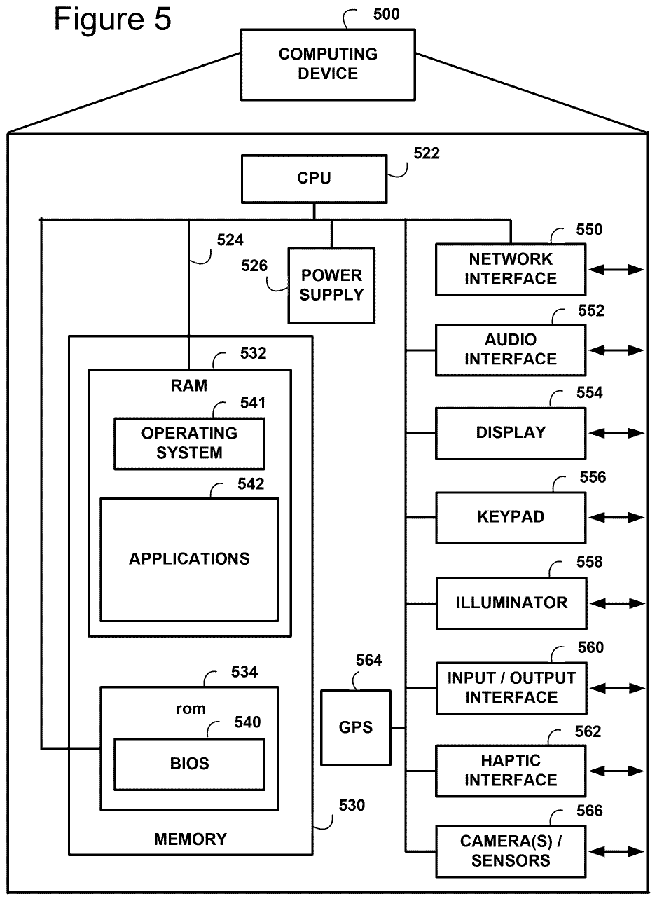

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a central processing unit (CPU) 522 in communication with a mass memory 530 via bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566, and power supply 526. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 (e.g., as part of ROM 534) for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, provide other information that may be employed to determine a physical location of the device, including, for example, a MAC address, IP address, or the like.

The present disclosure has been described with reference to the accompanying drawings, which form a part hereof, and which show, by way of a non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by computing device, for a plurality of network devices of a communications network, actual parametric values corresponding to multiple network communications path optimization factors;
obtaining, by the computing device, target parametric values for the multiple path optimization factors, the target parametric values comprising target values corresponding to the actual parametric values;
generating, by the computing device, model input for the plurality of network devices using the obtained actual and target parametric values;
generating, by the computing device, path optimization recommendation information using a path optimization model and the model input, the path optimization recommendation information indicating at least one recommendation for optimizing a communications path of the communications network; and
causing, by the computing device, at least one configuration change to the communications network in accordance with the at least one recommendation for optimizing a communications path of the communications network.

2. The method of claim 1, further comprising:
providing, by the computing device, network inventory information and current configuration information about the communications network to the path optimization model, wherein the path optimization recommendation information is generated by the path optimization model using the model input, network inventory information and current configuration information.

3. The method of claim 1, further comprising:
determining, by the computing device, to take an action recommended in the path optimization recommendation information using a corresponding recommendation priority indicated in the path optimization recommendation information, the determining comprising making a determination that the corresponding recommendation priority exceeds a threshold priority.

4. The method of claim 1, causing at least one configuration change to the communications network further comprising:
determining, by the computing device, to take an action comprising changing bandwidth of a communications path of the communications network; and
instructing, by the computing device, a configuration manager associated with a respective network device of the plurality of network devices to change bandwidth in connection with a port of the respective network device.

5. The method of claim 1, causing at least one configuration change to the communications network further comprising:
determining, by the computing device, to take an action comprising diverting at least some traffic in connection with a communications path of the communications network; and
instructing, by the computing device, a configuration manager associated with a respective network device of the plurality of network devices to divert at least a portion of traffic in connection with a port of the respective network device to another port of the respective network device.

6. The method of claim 1, causing at least one configuration change to the communications network further comprising:
determining, by the computing device, to take an action comprising increasing bandwidth and diverting at least some traffic in connection with a communications path of the communications network; and
instructing, by the computing device, a configuration manager associated with a respective network device of the plurality of network devices to change bandwidth in connection with a port of the respective network device and to divert at least a portion of traffic in connection with the port of the respective network device to another port of the respective network device.

7. The method of claim 1, wherein the communications path optimization factors comprise factors selected from one or more of the following: quality of experience (QES), utilization, capacity, packet drops, power loss or temperature.

8. The method of claim 1, further comprising:
generating, by the computing device, current configuration information for the communications network, the current configuration information comprising the at least one configuration change to the communications network made in accordance with the at least one recommendation for optimizing a communications path of the communications network.

9. The method of claim 1, obtaining actual parametric values further comprising:
obtaining, by computing device, the actual parametric values corresponding to at least some of the multiple network communications path optimization factors from at least one sensor of each of the plurality of network devices of the communications network.

10. The method of claim 1, generating path recommendation information further comprising:
generating, by computing device, using the path optimization model and the model input, an actual score for the at least one recommendation for optimizing a communications path of the communications network;
generating, by the computing device, a recommendation priority corresponding to the at least one recommendation using the path optimization model, the actual score and a target score; and
generating, by the computing device, the path optimization recommendation information comprising the at least one recommendation and the corresponding recommendation priority.

11. The method of claim 10, wherein path optimization recommendation information further comprises the actual score.

12. The method of claim 1, wherein the communications network is for communications between a plurality of instances of user equipment and a network core of a 5G service provider.

13. A non-transitory computer-readable storage medium tangibly encoded with computer-executable instructions that when executed by a processor associated with a computing device perform a method comprising:
obtaining, for a plurality of network devices of a communications network, actual parametric values corresponding to multiple network communications path optimization factors;
obtaining target parametric values for the multiple path optimization factors, the target parametric values comprising target values corresponding to the actual parametric values;
generating model input for the plurality of network devices using the obtained actual and target parametric values;
generating path optimization recommendation information using a path optimization model and the model input, the path optimization recommendation information indicating at least one recommendation for optimizing a communications path of the communications network; and
causing at least one configuration change to the communications network in accordance with the at least one recommendation for optimizing a communications path of the communications network.

14. The non-transitory computer-readable storage medium of claim 13, the method further comprising:
providing network inventory information and current configuration information about the communications network to the path optimization model, wherein the path optimization recommendation information is generated by the path optimization model using the model input, network inventory information and current configuration information.

15. The non-transitory computer-readable storage medium of claim 13, the method further comprising:
determining to take an action recommended in the path optimization recommendation information using a corresponding recommendation priority indicated in the path optimization recommendation information, the determining comprising making a determination that the corresponding recommendation priority exceeds a threshold priority.

16. The non-transitory computer-readable storage medium of claim 13, causing at least one configuration change to the communications network further comprising:
determining to take an action comprising changing bandwidth of a communications path of the communications network; and
instructing a configuration manager associated with a respective network device of the plurality of network devices to change bandwidth in connection with a port of the respective network device.

17. The non-transitory computer-readable storage medium of claim 13, causing at least one configuration change to the communications network further comprising:
determining to take an action comprising diverting at least some traffic in connection with a communications path of the communications network; and
instructing, a configuration manager associated with a respective network device of the plurality of network devices to divert at least a portion of traffic in connection with a port of the respective network device to another port of the respective network device.

18. The non-transitory computer-readable storage medium of claim 13, causing at least one configuration change to the communications network further comprising:
determining to take an action comprising increasing bandwidth and diverting at least some traffic in connection with a communications path of the communications network; and
instructing a configuration manager associated with a respective network device of the plurality of network devices to change bandwidth in connection with a port of the respective network device and to divert at least a portion of traffic in connection with the port of the respective network device to another port of the respective network device.

19. The non-transitory computer-readable storage medium of claim 13, wherein the communications path optimization factors comprise factors selected from one or more of the following: quality of experience (QES), utilization, capacity, packet drops, power loss or temperature.

20. A device comprising:
a processor, configured to:
obtain, for a plurality of network devices of a communications network, actual parametric values corresponding to multiple network communications path optimization factors;
obtain target parametric values for the multiple path optimization factors, the target parametric values comprising target values corresponding to the actual parametric values;
generate model input for the plurality of network devices using the obtained actual and target parametric values;
generate path optimization recommendation information using a path optimization model and the model input, the path optimization recommendation information indicating at least one recommendation for optimizing a communications path of the communications network; and
cause at least one configuration change to the communications network in accordance with the at least one recommendation for optimizing a communications path of the communications network.
